(19) United States
(12) Patent Application Publication
(10) Pub. No.: US 2009/0165390 A1
(43) Pub. Date: Jul. 2, 2009

(54) GASKET

(75) Inventor: Hyoung Tae Yoon, Gyeyang-gu (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 12/343,532

(22) Filed: Dec. 24, 2008

(30) Foreign Application Priority Data
Dec. 27, 2007 (KR) 10-2007-0139531

(51) Int. Cl. E06B 7/20

(52) U.S. Cl. 49/478.1

(57) ABSTRACT

A gasket includes a coupling part coupled to a door frame; an opposing part opposite to a door glass and formed integrally with the coupling part; and a magnetic part formed integrally with the coupling part.

### CROSS-REFERENCE TO RELATED APPLICATIONS

The present application claims priority to Korean patent application number 10-2007-0139531, filed on Dec. 27, 2007, which is incorporated by reference in its entirety.

### BACKGROUND OF THE INVENTION

The present invention relates to a gasket and an extrusion method for the gasket, and more particularly, to a gasket which allows easy opening of a door and can be manufactured with reduced cost, an extrusion method for the gasket.

In general, a dryer is an appliance for automatically drying wet objects to be dried (for example, laundries) to which washing operation is completed, and is provided with a rotatable drum, a driving apparatus for driving the drum and a heater for generating hot dry wind, in an inside of a body cabinet.

FIG. 1 is a perspective view illustrating a conventional dryer. The dryer is provided with a drying drum 10 rotatably mounted inside of a body which forms an external appearance of the dryer and a driving apparatus (not shown) for driving the drying drum 10.

The drying drum 10 is connected with a flow path (not shown) for supplying hot wind and a flow path (not shown) for exhausting the hot wind. A heater (not shown) for heating air flowed in from an outside of the body is installed on the hot wind supplying path. Also, a blower fan (not shown) for forcibly blowing the air heated by the heater into an inside of the drum as well as exhausting the air completing the dry to the outside of the body is installed on the hot wind exhausting path.

The body of the dryer includes a side cabinet 20 which forms a side face of the body, a back cover (not shown) which forms a rear face of the body, a base cabinet (not shown) which forms a lower face of the body, a cabinet cover 30 which forms a front face of the body and is provided with an opening 35 for allowing laundries to be putted in or drawn out therethrough, a top plate 40 which forms an upper face of the body and a control panel 50 which is placed between the cabinet cover 30 and the top plate 40 and is provided with various switches.

The cabinet cover 30 is provided with a door 60 which is pivotally hinged at one side of the opening 35 to open and close the opening 35.

A gasket 70 is provided on an inner periphery of the door 60, which is in contact with the opening 35 of the cabinet cover 30, to seal between the door 60 and the body.

Also, a hook (not shown) is provided on the inner periphery of the door 60 to be locked in a locking part (not shown), thereby preventing arbitrary opening after the door 60 is closed.

In the conventional dryer, since an external force for releasing the locking should be applied in order to open the locked door, there is a problem that the weak and the elderly cannot easily open the door.

Also, there is a problem that the hook and the locking part may be damaged when a user applies an excessive force to open the door in a state that he/her does not recognize know the door is locked.

Also, there is a problem that it takes much manufacturing cost as a complex locking apparatus such as the hook and the locking part should be separately manufactured.

Further, since it is impossible to open the door from the inside of the drying drum, a safety problem may occur when the door is closed and the hook is locked in the locking part after a child enters into the drying drum. Therefore, it is required to improve the problems.

### SUMMARY OF THE INVENTION

Embodiments of the present invention are directed to a gasket which allows easy opening of a door and can be manufactured with reduced cost, an extrusion method for the gasket and a dryer having the gasket.

In one embodiment, a gasket includes a coupling part coupled to a door frame; an opposing part opposite to a door glass and formed integrally with the coupling part; and a magnetic part formed integrally with the coupling part.

Preferably, the magnetic part is formed integrally with the coupling part by an extrusion moulding.

Preferably, the magnetic part is placed inside of the coupling part.

More preferably, the coupling part is provided with a hollow part therein and the magnetic part is disposed closer than the hollow part to an opening through which laundries are putted in.

Preferably, the coupling part is formed concave so as to be fitted in the door frame.

In another embodiment, a gasket includes a coupling part coupled to a door frame; and an opposing part opposite to a door glass and formed integrally with the coupling part, wherein the coupling part is formed including a material having magnetism.

Preferably, the coupling part is provided with a hollow part therein.

Preferably, the coupling part is formed concave so as to be fitted in the door frame.

### BRIEF DESCRIPTION OF THE DRAWINGS

FIG. 1 is a perspective view illustrating a conventional laundry dryer.

FIG. 2 is a perspective view illustrating a dryer to which a gasket in accordance with an embodiment of the present invention.

FIG. 3 is a side sectional view illustrating the dryer to which the gasket in accordance with an embodiment of the present invention.

FIG. 4 is an enlarged view of the gasket in FIG. 3.

FIG. 5 is a flowchart illustrating an extrusion moulding method for the gasket in accordance with an embodiment of the present invention.

FIG. 6 is a flowchart illustrating an extrusion moulding method for the gasket in accordance with another embodiment of the present invention.

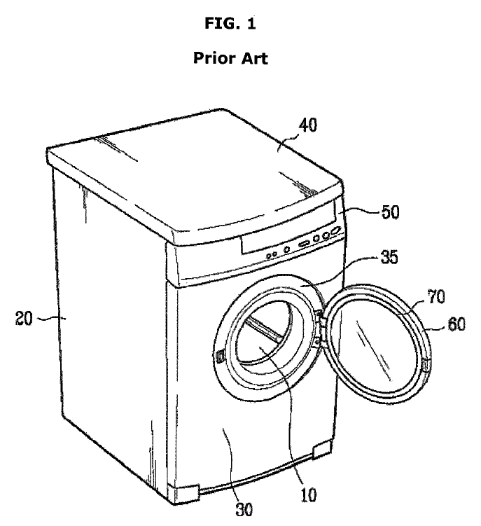

### DESCRIPTION OF SPECIFIC EMBODIMENTS

Hereinafter, an exemplary embodiment of the present invention will be described with reference to accompanying drawings.

It should be noted that the drawings are not to precise scale and may be exaggerated in thickness of lines or size of components for the purpose of convenience and clarity only.

Furthermore, terms used herein are defined in consideration of functions in the present invention and can be changed according to the custom or intention of users or operators.

Thus, definition of such terms should be determined according to overall disclosures set forth herein.

For convenience of description, a gasket mounted in a dryer will be described by way of example.

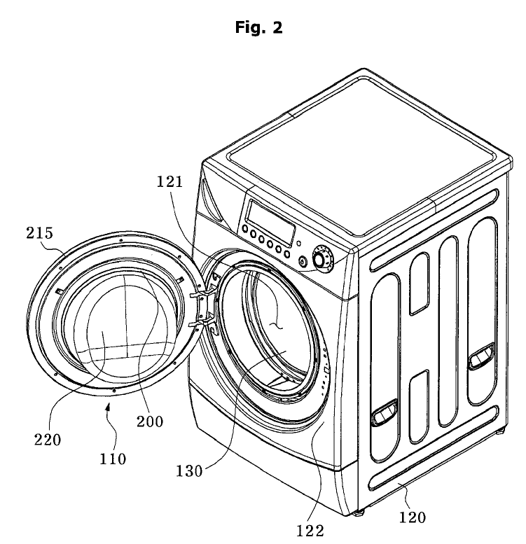

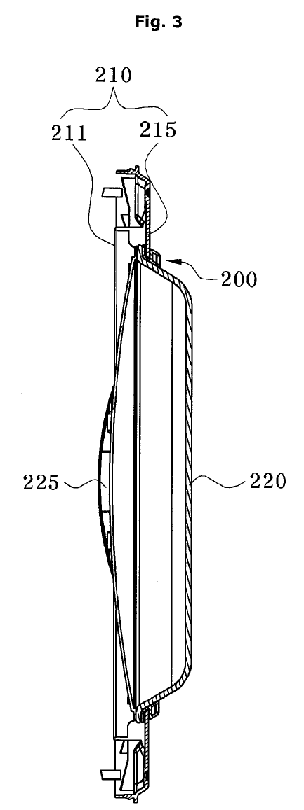

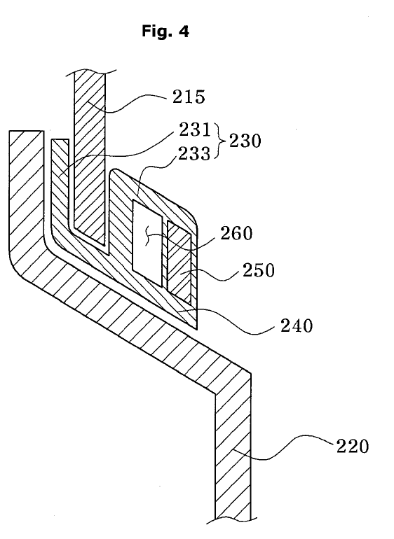

FIG. 2 is a perspective view illustrating a dryer to which a gasket in accordance with an embodiment of the present invention; FIG. 3 is a side sectional view illustrating the dryer to which the gasket in accordance with an embodiment of the present invention; and FIG. 4 is an enlarged view of the gasket in FIG. 3.

Herein, the parts same as or similar to those of in the above described embodiment will not be described again in detail.

Referring to FIGS. 2 to 4, the body of the dryer includes a side cabinet 120 which forms a side face of the body, a back cover (not shown) which forms a rear face of the body, a base cabinet (not shown) which forms a lower face of the body, a cabinet cover 122 which forms a front face of the body and is provided with an opening 121 for allowing laundries to be putted in or drawn out therethrough and a top plate (not shown) which forms an upper face of the body. An inside of the body is provided with a drum 130 in which laundries to be dried are putted and dried.

The cabinet cover 122 is provided with a door 110 pivotally hinged at one side of the opening 121 to open and close the opening 121.

The door 110 includes a ring shaped door frame 210 having an opening (not shown) at the center thereof, a door glass 220 mounted in the opening and a door cover 225 provided in front of the door glass 220 to protect the door glass 220.

The door frame 210 includes an outer door fame 211 which forms an outer face of the door frame 210 and an inner door frame 215 which forms an inner face of the door frame 210.

The door glass 220 is formed so as to be projected toward the opening 121. Therefore, when the door 110 is closed, the door glass 220 gets inside the opening 121 to prevent the laundries to be dried to be gathered in the vicinity of the door 110.

Also, the door glass 220 is preferably made of a transparent material which allows a grasp of the state inside the drying drum 130.

The door cover 225 is coupled to the door frame 210 in such a way that its outer peripheral face is coupled to an inner periphery of the outer door frame 211.

An inner periphery of the door 110 which is brought in contact with the opening 121 is provided with a gasket 200 so that the door 110 seals the body.

The gasket 200 has generally a ring shape and includes a coupling part 230 coupled to the door frame 210, and an opposing part 240 and a magnetic part 250 formed integrally with the coupling part 230.

The coupling part 230 has a concaved side portion and is fitted to the door frame 210, specifically the inner door frame 215. That is to say, the inner door frame 215 is inserted between the front portion 231 and the rear portion 233 of the coupling part 230.

The coupling part 230 is made of an elastic material and air is not leaked out through a space between the inner door frame 215 and the coupling part 230 since the coupling part 230 is tightly coupled to the inner door frame 215.

The magnetic part 250 is formed integrally with the coupling part 230 by an extrusion moulding and is disposed inside the coupling part 230. That is to say, the magnetic part 250 is surrounded by the coupling part 230.

Although the magnetic part 250 having magnetism is formed integrally with the coupling part 230 to give the magnetism to the gasket 200 in the present embodiment, the gasket itself may have the magnetism without the magnetic part 250.

A material having the magnetism, for example, ferrite powder is mixed in a raw material of the gasket 200 and then the coupling part 230 and the opposing part 240 may be formed by the extrusion moulding using the mixed material. Herein, the raw material of the gasket 200 means materials conventionally used to manufacture the gasket 200, such as silicon and Thermo Plastic Rubber (TPR).

As described above, by manufacturing the gasket 200 so that the separate magnetic part 250 is provided or the gasket 200 itself includes the material having the magnetism instead of using the magnetic part 250, the magnetism is given to the gasket 200. A user can close the door 110 without much effort since the gasket 200 is magnetically coupled to the periphery of the opening 121 which is made of a metal material when the opening 121 is closed by the door 110.

Since the closed door 110 can be opened by applying only such a force that can release the magnetic coupling, it is possible to open the door 110 even in the drying drum 130 by applying only a force stronger than a predetermined force. Therefore, when a child is kept in the drying drum 130, the child can easily open the door 110 and get out of the drying drum 130.

Also, since the magnetic coupling is released before an excessive force is applied, it is possible to prevent structural parts from being damaged when the door 110 is opened and closed.

The coupling part 230 is provided with a hollow part 260 therein. The hollow part 260 absorbs impact and noise generated when the door 110 is closed and prevents the deformation of the gasket 200 when the door 110 is opened and closed. In order to obtain more effective operation, the magnetic part 250 is disposed closer to the opening 121 than the hollow part 260.

Therefore, the impact or the like generated when the door 110 closes the opening 121 is primarily absorbed by the coupling part 230 of the elastic material and is secondarily absorbed by the hollow part 260 of the coupling part 230.

The opposing part 240 is opposite to a periphery of the portion projected toward the opening 121 in the door glass 220, and is formed integrally with the coupling part 230 by the extrusion moulding.

The opposing part 240 is for preventing that the laundries to be dried are held between the door glass 220 and the gasket 200 and may thus be formed so as to be in close contact with the door glass 220.

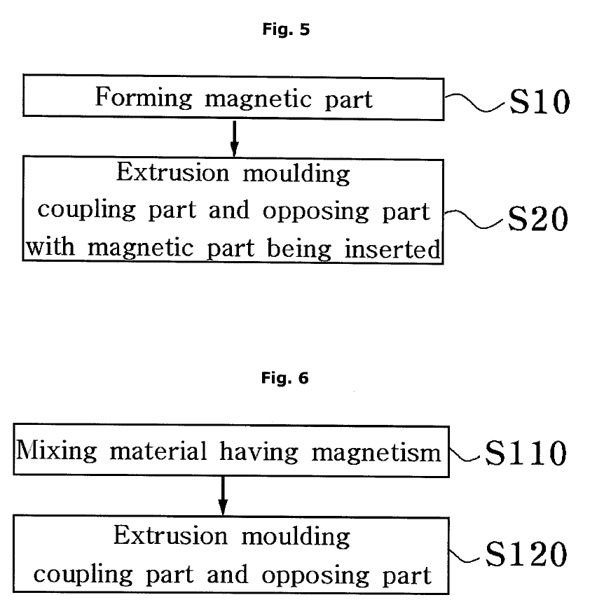

FIG. 5 is a flowchart illustrating an extrusion moulding method for the gasket in accordance with an embodiment of the present invention. The gasket 200 is manufactured by the following steps.

First, the magnetic part 250 having the magnetism is moulded (S10) and the coupling part 230 and the opposing part 240 are extrusion moulded with the magnetic part 250 being inserted therein (S20).

As described above, the coupling part 230 has a structure that is fitted in the door frame 210, specifically the inner door frame 215 and the opposing part 240 has a structure that is opposite to, more preferably in close contact with the door glass 220.

Upon the extrusion moulding, the hollow part 260 which is spaced apart from the opening 121 more than the magnetic part 250. Of course, the step after the step S10 of moulding the magnetic part 250 may be suitably changed if necessary.

The hollow part 260 may be moulded using a mould formed with a projection part corresponding to the hollow part 260 or by inserting a core corresponding to the hollow part 260 in an inside of the mould.

Herein, the core has a shape corresponding to the hollow part 260, and the structure thereof is well known in the art and will not be described herein.

Both ends of the coupling part 230, the opposing part 240 and the magnetic part 250 extrusion moulded in a shape of a bar are brought in contact to be coupled with each other so as to correspond to the ring shaped door frame 210. After that, the both ends of the coupling part 230, the opposing part 240 and the magnetic part 250 are fixed to a ring shape by thermal treatment or adhesion.

FIG. 6 is a flowchart illustrating an extrusion moulding method for the gasket in accordance with another embodiment of the present invention. The gasket 200 is manufactured by the following steps. Herein, duplicated descriptions with the above described embodiment will be omitted.

First, the magnetic material is mixed in the raw material of the gasket 200 (S110). Herein, the raw material of the gasket 200 refers to materials conventionally used to manufacture the gasket 200, such as silicon and Thermo Plastic Rubber (TPR). In the present embodiment, the ferrite powder is used as the magnetic material.

After that, the coupling part 230 and the opposing part 240 are extrusion moulded using the mixed materials (S120).

Upon the extrusion moulding, the hollow part 260 is formed inside the coupling part 230. Of course, the step after the step S110 of mixing material having magnetism may be suitably changed if necessary.

Although the present invention has been described with reference to the embodiments shown in the drawings, it should be understood that these embodiments are provided for illustrative purpose and that various equivalent modifications and alterations will be apparent to those skilled in the art without departing from the scope and spirit of this invention.

In addition, although the present invention has been described with reference to the dryer as specifically described herein, it should be noted that the dryer has been illustrated by way of example, and that the gasket of the present invention may be applied to other product such as a drum type washing machine, without being limited to the dryer in its application.

Therefore, the scope and spirit of the invention is limited only by the claims set forth herein as follows.

What is claimed is:

1. A gasket, comprising:
a coupling part coupled to a door frame;
an opposing part opposite to a door glass and formed integrally with the coupling part; and
a magnetic part formed integrally with the coupling part.

2. The gasket of claim 1, wherein the magnetic part is formed integrally with the coupling part by an extrusion moulding.

3. The gasket of claim 1, wherein the magnetic part is placed inside of the coupling part.

4. The gasket of claim 3, wherein the coupling part is provided with a hollow part therein and the magnetic part is disposed closer than the hollow part to an opening through which laundries are putted in.

5. The gasket of claim 1, wherein the coupling part is formed concave so as to be fitted in the door frame.

6. A gasket, comprising:
a coupling part coupled to a door frame; and
an opposing part opposite to a door glass and formed integrally with the coupling part,
wherein the coupling part is formed including a material having magnetism.

7. The gasket of claim 6, wherein the coupling part is provided with a hollow part therein.

8. The gasket of claim 6, wherein the coupling part is formed concave so as to be fitted in the door frame.
